(19) United States
(12) Patent Application Publication
(10) Pub. No.: US 2022/0155591 A1
(43) Pub. Date: May 19, 2022

(54) EYEBOX EXPANDING VIEWING OPTICS ASSEMBLY FOR STEREO-VIEWING

(71) Applicant: RAXIUM, INC., Fremont, CA (US)

(72) Inventor: Michael Anthony Klug, Austin, TX (US)

(21) Appl. No.: 17/527,081

(22) Filed: Nov. 15, 2021

Related U.S. Application Data
(60) Provisional application No. 63/113,375, filed on Nov. 13, 2020.

(51) Int. Cl. G02B 27/01; G02B 27/18; G09F 9/33; G02B 5/18

(52) U.S. Cl. CPC G02B 27/0101; G02B 27/18; G02B 2027/0134; G02B 5/1842; G09F 9/33

(57) ABSTRACT

A stereo viewing system includes a projector and an eyepiece. The projector includes a first microdisplay and emits first and second spatially-modulated light associated with a first image and second image, respectively. The eyepiece includes an eyepiece substrate, a first and second input coupling element, and a first and second output coupling element. The first input coupling element receives the first spatially-modulated light from the projector and incouples the first spatially-modulated light into the eyepiece substrate. The first output coupling element projects at least a portion of the incoupled spatially-modulated light out of the eyepiece substrate from a user-side surface of the eyepiece substrate. The second input coupling element incouples the second spatially-modulated light, received from the projector, into the eyepiece substrate. The second output coupling element projects at least a portion of the incoupled spatially-modulated light out of the eyepiece substrate from the user-side surface.

### CROSS REFERENCE TO RELATED APPLICATIONS

The present application claims the benefit of U.S. Provisional Patent Application No. 63/113,375, filed Nov. 13, 2020, and entitled “Eyebox Expanding Viewing Optics Assembly For Stereo-Viewing.”

### BACKGROUND

Limited pupil (or “eye-box”) size is a challenge for stereo displays, such as binocular refractive optic-based stereo displays used for robotic and telesurgery or for remote piloting of vehicles, for example. Virtual Reality (VR) solutions, offering constrained user-to-pupil alignment by virtue of a worn display are not viable for applications in which the user must intermittently look away from the display and toward the physical world around them. Multi-view approaches, as implemented with lenticular screens and raster barriers, produce a trade-off of resolution and image quality, due to optical artifacts that are difficult to eliminate within such displays. A solution to overcome such problems with existing display systems would be desirable.

### SUMMARY OF THE DISCLOSURE

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

The present disclosure describes a stereo viewing system including a first projector having a first microdisplay configured to emit spatially modulated light associated with a first image, and a first eyepiece substrate having a world side surface and a user side surface. The first eyepiece substrate includes a first input coupling element and a first output coupling element. The first input coupling element is configured to incouple the spatially modulated light into the first eyepiece substrate, and the first output coupling element is also configured to project at least a portion of the incoupled spatially modulated light out of the first eyepiece substrate toward the user side.

The present disclosure further describes a stereo viewing system having a first projector with a first microdisplay configured to emit spatially modulated light associated with a first image, a second microdisplay configured to emit spatially modulated light associated with a second image, and a first eyepiece stack having a world side and a user side. The first eyepiece stack includes at least a first and a second eyepiece substrate layer aligned along a viewing axis. The first eyepiece substrate layer includes a first input coupling element and a first output coupling element. The second eyepiece substrate layer includes a second input coupling element and a second output coupling element. The first input coupling element is configured to incouple the spatially modulated light associated with the first image into the first eyepiece substrate layer, and the first output coupling element is also configured to project at least a portion of the incoupled spatially modulated light out of the first eyepiece substrate layer toward the user side. The second input coupling element is configured to incouple the spatially modulated light associated with the second image into the second eyepiece substrate layer and the second output coupling element is configured to project at least a portion of the incoupled spatially modulated light out of the second eyepiece substrate layer toward the user side.

### BRIEF DESCRIPTION OF THE DRAWINGS

The appended drawings illustrate only some implementations and are therefore not to be considered limiting of scope.

FIG. 1 illustrates a top-down view of a lens-based optical system.

FIG. 2 illustrates a top-down view of a lenslet-based optical system.

FIG. 3 illustrates a top-down view of a tilted lenslet-based optical system.

FIG. 4 illustrates a front view of a tilted lenslet array overlaying a pixel array, in accordance with an embodiment.

FIG. 5 illustrates a top-down view of a waveguide-based optical system having a single projector, in accordance with an embodiment.

FIG. 6 illustrates a top-down view of an example light path through an eyepiece substrate, in accordance with an embodiment.

FIG. 7 illustrates a top-down view of a waveguide-based optical system having two projectors, in accordance with an embodiment.

FIG. 8 illustrates a front view of an eyebox of user of a waveguide-based optical system, in accordance with an embodiment.

FIG. 9 illustrates a side view of a user operating a boom-mounted waveguide-based optical system projecting an image at the viewer's hands, in accordance with an embodiment.

FIG. 10 illustrates a top-down view of example light paths through an eyepiece substrate of a diffractive waveguide eyebox-expanding optical system.

FIG. 11 illustrates a top-down view of example light paths through an eyepiece incorporating a reflective surface to re-direct forward-diffracted image light from a waveguide-based optical system.

FIG. 12 illustrates a top-down view of a spatially-multiplexed, waveguide-based optical system, in accordance with an embodiment.

FIG. 13 illustrates a top-down view of a temporally-multiplexed, waveguide-based optical system, in accordance with an embodiment.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “compromising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

The present disclosure describes embodiments of an alternative viewing optics assembly combining two high density emissive displays, such as micro light emitting diode (microLED) panels, with pupil-expanding waveguide windows. Such a configuration can provide high resolution stereo imagery with large eye-boxes, to enable comfortable viewing with minimal artifacts over any selected field of view.

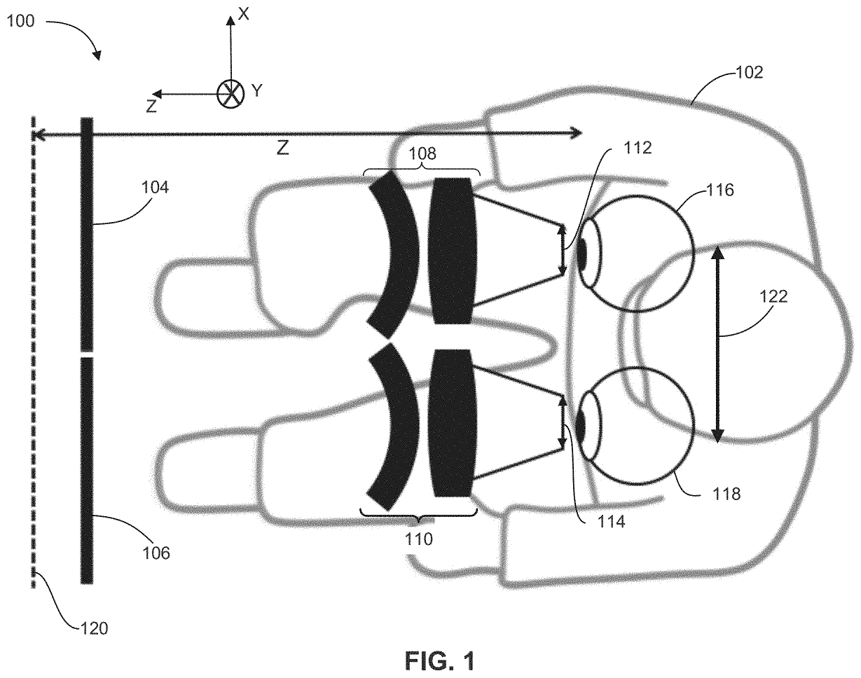

FIG. 1 illustrates a top-down view of an optical system 100 typically used as an interface between a user 102 and remote equipment operatively coupled therewith, such as a telesurgery robot or a remotely piloted vehicle. FIGS. 1-3, 5, and 7 include user 102 to illustrate the respective top-down of each figure; user 102 is not drawn to scale.

The system 100 includes a right display 104 and a left display 106 that project right and left image data, respectively, via spatially modulated light toward a right optical sub-assembly 108 and a left optical sub-assembly 110, respectively. The left and right image data may be slightly different, or offset, to provide stereo input to the user's eyes. The optical sub-assemblies 108, 110 can include one or more lenses, prisms, or other optical elements to direct the light from right and left displays 104 and 106, respectively, into right and left eyebox regions 112 and 114, respectively, where it can be received by a user's right and left eyes 116, 118, respectively, when the pupils of user's eyes 116, 118 overlap the eyebox regions 112, 114. It is noted that the items shown in FIG. 1, such as the eyebox regions and optical sub-assemblies, are not to scale and are exaggerated in size for illustrative clarity. Similar exaggerations are used throughout the present disclosure. The redirected light is received onto the retinas of the user's eyes as an image perceived by the user 102. The perceived image is located on an image plane 120 that can be moved closer to or further from the user 102 along a viewing axis z by adjusting one or more components of the optical sub-assemblies 108, 110.

Notably, the eyebox regions 112, 114 for stereoscopic and prismatic optics, such as in the optical sub-assemblies 108, 110 of system 100, are limited in lateral (i.e., x direction) size. Additionally, aberrations within the refractive optical sub-assemblies may produce significant optical artifacts for viewers whose eyes are not centered within the eyebox regions. As a result, image quality and/or viewing experience may be poor for many viewers. For example, viewers having an interpupillary distance (IPD) 122 that does not align with the distance between eyebox regions 112, 114 may be unable to simultaneously position the pupil of left and right eyes within the left and right eyebox regions 112, 114. Even fewer users will have an IPD that places both pupils in the center of the eyebox regions where image quality is highest. These deficiencies may be unacceptable in certain applications, such as robotic surgery, where full views of high quality, high resolution images are required for making high risk decisions.

Other drawbacks to the system 100 exist. Even for users who have an IPD that aligns perfectly with the eyebox regions 112, 114, very little movement of the user's head is tolerated while still maintaining the pupils within the eyebox regions. Still less movement is permissible in order to view the images with minimal artifacts. As a result, the user must remain almost completely stationary to keep both pupils centered within the eyebox regions. Such ergonomic constraints may be harmful or even impossible for a user to maintain over long periods of use.

Stereoscopic and prismatic optics are characterized by an inherent relationship between the lens f-number and pupil size. As the field of view increases, the pupil size decreases leading to reduced image quality. Finally, the optical system 100 must be enclosed within a bulky housing to minimize contrast-reducing ambient light scatter and to minimize other artifacts that may compromise image quality. Large housing sizes may prohibit systems like optical system 100 from being used in areas without plenty of spare room in which to place the equipment.

Other types of systems have been developed to address various deficiencies discussed with respect to the optical system 100. In one example, head-mounted systems can be used. Head-mounted systems are generally stationary (i.e., affixed in relative position) with respect to the user's eyes at all times, thereby allowing a user to move their head without causing misalignment between the user's eye and the display. However, head-mounted systems, and in particular head-mounted virtual reality (VR) systems, are cumbersome in applications that require a user to look away from the display system intermittently in order to view or interact with other objects or people in the user's environment.

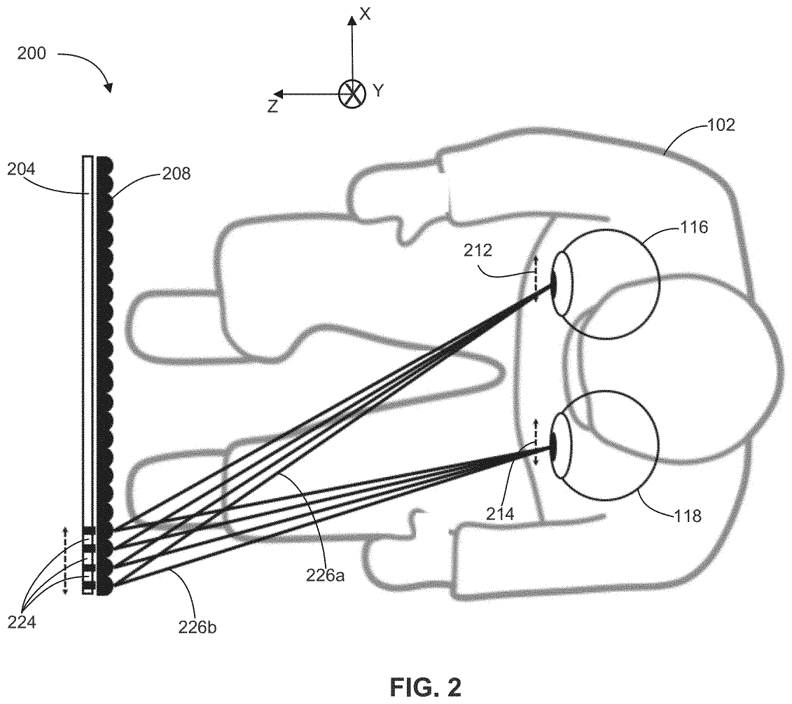

Another type of optical system 200 used in an attempt to overcome the aforedescribed problems with system 100 is shown in a top-down view in FIG. 2. The system 200 includes a pixelated display 204 including a plurality of pixels 224 which can be alternating left and right perspective-bearing pixels. Light from selectively actuated pixels travels through a plurality of lenticular lenslets in a lenslet array 208 which produce collimated, angularly-separated emergent beams, such as angularly-separated beams 226a, 226b. A plurality of angularly-separated beams produced by the lenslet array collect at a right eyebox region 212 and a left eyebox region 214 where the user 102 can view the images with right and left eyes 116, 118, respectively. Some lenslet-based systems employ an eye-tracking component which can recognize the location of the user's eyes and/or pupils and can activate different groups of pixels 224 to improve alignment between the eyebox regions 212, 214 and the user's eyes 116, 118.

While the system 200 can be more compact than the system 100 and can include mechanisms for accommodating a range of user IPDs, the images produced by system 200 can suffer from poor image quality. Artifacts such as crosstalk and ghosting may be present in the images delivered to a user's eyes due to lenslet imperfections, misalignments between the lenslets and the pixels, and the simplification of lenslet design required in order to make the lenslet arrays manufacturable. The lenslets may further produce a texture on the display surface that can contribute to loss of image quality and/or distract a user. Additionally, lenslet prescriptions may give rise to vignetting and reduced redirection coherence for higher off-axis pixels and exit angles. The system 200 also sacrifices spatial resolution in favor of using perspective-bearing pixels, which limits the fidelity of the image perceived by a user.

In addition to lacking sufficient image quality, the system 200 may suffer from the inability to adjust an image location. The image in a lenslet-based optical system 200 is located at the display 204. Approaches to offset the depth location of the image along the viewing axis, z, generally produces significant image blur as well as astigmatic and other optical aberrations.

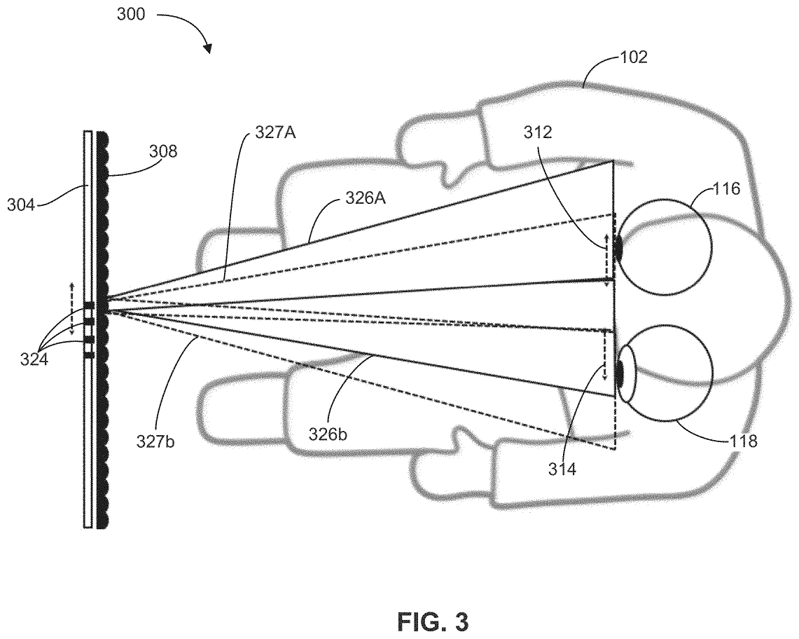

FIG. 3 illustrates a top-down view of an alternate configuration of a lenslet-based optical system 300, also used in an attempt to overcome the issues of previously described systems 100 and 200. The system 300 includes a pixelated display 304 having a plurality of pixels 324 that can be selectively actuated. Light from the actuated pixels is directed through a plurality of lenslets on a lenslet array 308.

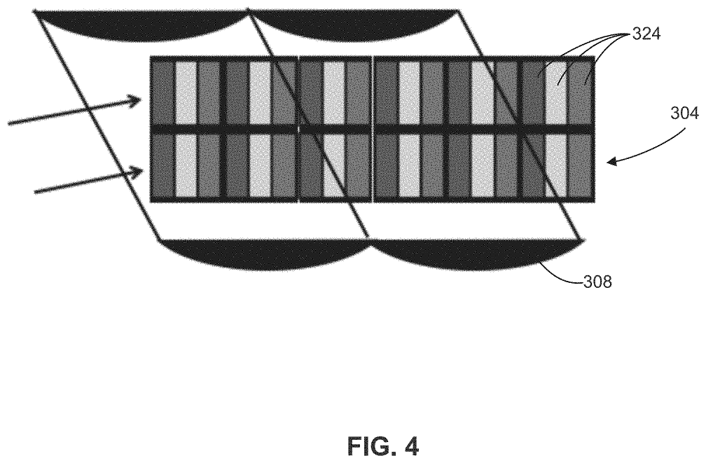

Referring to FIGS. 3 and 4 together, lenslets 308 are shown in a tilted configuration with respect to the array of pixels 324 on the pixelated display 304. The top row of pixels, or a subset of the top row of pixels, 328 provides light to the left-shifted eyebox region 314 while the bottom row of pixels, or a subset of the bottom row of pixels, 330 provides light to the right-shifted eyebox region 312. Light passing through the tilted lenslets is directed into two angularly-separated divergent beams 326a, 326b and can be viewed by user 102 when the user's right and left eyes 116, 118 when they are positioned within the right and left eyebox regions 312, 314. This tilted lenslet configuration can help to increase eyebox region offset in the horizontal direction (i.e., x direction) as indicated by two angularly-separated divergent beams 327a, 327b. However, the increase in offset, the range of locations in which the projected image may be viewed by user 102, comes at the expense of vertical image resolution. As discussed above, sacrifices to image quality and resolution may be unacceptable in certain applications where maximum image fidelity and detail is required.

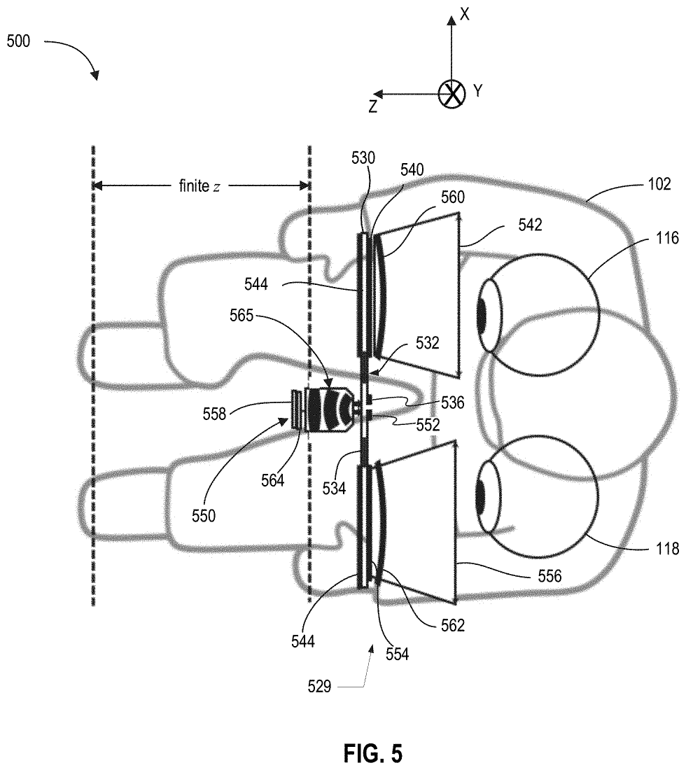

FIG. 5 shows a top-down view of a waveguide-based stereo optical system 500, in accordance with an embodiment. The system 500 includes an eyepiece having a waveguide which is referred to herein as eyepiece substrate 530. The eyepiece substrate 530 is formed from a polymer, glass, or other material and, in an example, is configured to receive and guide light therein by total internal reflection (TIR). The eyepiece substrate 530 further includes a user side surface 532, which is oriented toward the eyes of user 102, and a world side surface 534 opposite the user side surface and oriented away from the user 102. In some embodiments, the user side surface 532 may be a planar surface substantially perpendicular to a viewing axis (i.e., z direction). The world side surface 534 may be substantially parallel to the user side surface 532 such that the eyepiece substrate 530 has minimal thickness variation over its height (i.e., y direction into the page) and width (i.e., x direction). Minimizing thickness variation may reduce the occurrence or severity of certain types of image artifacts, thereby improving image quality. It is noted that eyepiece substrate 530 may be a single piece of material, such as glass or plastic, or be split into two separate eyepieces.

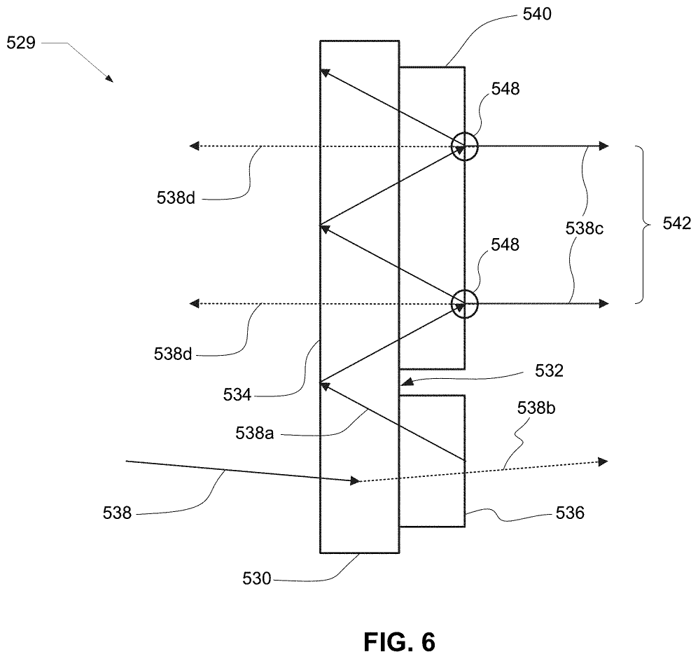

Referring to FIGS. 5 and 6 together, an eyepiece 529 includes an eyepiece substrate 530 having a plurality of optical elements 536, 540 disposed on the user side surface 532. One of skill in the art will appreciate that optical elements may be disposed on one or both of the user side and/or world side surfaces 532, 534 as a matter of design choice. The optical elements include a first input coupling element 536 configured to receive spatially-distributed, angularly multiplexed pixel information via light 538 from a projector 550. The input coupling element 536 is configured to modify the direction of travel of the received light 538 so that at least a first portion 538a of the received light is propagated in TIR through the eyepiece substrate 530. In some embodiments, due to particular angles of the incoming light 538 or designs of the input coupling element 536, a second portion 538b of light may pass through the input coupling element 536 and the eyepiece substrate 530 without being guided in TIR. The second portion 538b may be considered wasted light if it does not contribute to projecting the image in a location where a user 102 can see it. In some embodiments, a reflective coating may be placed over the input coupling element 536 to recapture some or all of the second portion 538b of light that may have otherwise been wasted.

The eyepiece substrate 530 further includes a first output coupling element 540 configured to interact with the first portion 538a of light traveling through the eyepiece substrate 530 in TIR. At each interaction with the output coupling element 540, represented by circles 548, the trajectory of a percentage of light is modified such that it is directed out of the eyepiece substrate 530. Generally, some of the modified light is directed toward a user 102 as third portion 538c of light and the some of the modified light is directed away from a user 102 as fourth portion 538d of light, opposite to the direction of third portion 538c. In some configurations, fourth portion 538d will not be seen by a user 102 and is considered wasted light. Similar to the reflective coating discussed above with respect to the input coupling element, a reflective coating 544 may be disposed over the output coupling element 540 or over a portion of the world side surface 534 aligned with the output coupling element 540 in order to reverse the direction of fourth portion 538d of light traveling away from user side 532 such that the reflected light can be directed toward the user's eye. That is, the reflective coating 544 redirects the fourth portion 538d of light back toward the user 102 where it may be seen by the user 102, thereby improving efficiency of the optical system. Alternatively, a reflective coating can be provided on an input coupling element 536, which may be a diffraction grating, to increase a diffraction efficiency of coupling element 536. Thus, by using a reflective coating, more light can be coupled into TIR angles through eyepiece substrate 530. The reflective or mirrored coating further provides a high level of non-scattering opacity. The mirror coating may be a broadband or narrow band coating as a matter of design choice.

One of skill in the art will appreciate that the percentage of light whose trajectory is modified at each interaction event 548 is determined by particular designs of the output coupling element 540. Light whose trajectory is not modified at each interaction with output coupling element 540 continues propagating through the eyepiece substrate in TIR where it may be modified at subsequent interaction events. Further, in-coupling element 536 and output coupling element 540 may be configured to operate in transmission mode, with the light rays shown in FIG. 6 traveling in the opposite direction. Moreover, a variety of alternative embodiments of input coupling elements and output coupling elements may be disposed on eyepiece substrate 530, such as on the opposing side of eyepiece substrate 530 from input coupling element 536 and output coupling element 540 shown in FIG. 6. Still further, an eyepiece may be formed of a single piece of material or two or more layers of materials. For example, when an eyepiece is formed of multiple layers of eyepiece substrates, each eyepiece substrate layer may convey a portion of the overall image, apportioned by wavelength, field angle, or other parameters of the light signal containing the overall image.

The area over which light is projected from the eyepiece substrate is considered the first eyebox region 542. Each beam within the third and fourth portions 538c, 538d of light projected from the eyepiece substrate contain a replica of the full image represented by the light 538 initially received into the eyepiece substrate from the projector 550. As such, a user need only receive a portion of third portion 538c of light in order to perceive the full image. Increasing the amount of light projected from the eyepiece substrate and/or increasing the area of the eyepiece substrate from which the relevant portions of are projected toward user 102 increases the likelihood that a user can see the full image from a wider range of eye positions. This large region in which the user's right eye 116 can see the full image is represented by the first eyebox region 542. In some embodiments, the footprint size of the output coupling element 540 on the eyepiece substrate may be selected to be in the range of approximately 2 inches by 2 inches, though other sizes and shapes are possible with specific dimensions being merely a design choice.

The eyepiece substrate 530 may further include a second input coupling element 552 and a second output coupling element 554 configured to direct light to a second eyebox region 556 for viewing by a user's left eye 118. The second input coupling element and second output coupling element may function in the same way as the first input coupling element and the first output coupling element discussed above. Additional reflective coatings may be disposed over one or more of the second input coupling element, the second output coupling element, or various portions of the user or world side surfaces.

Several variations of the system 500 are possible. For example, instead of or in addition to the reflective coating 544, an opaque coating or a dimmable backing panel may be used. Dimmable backing panels may be programmable so that the amount of dimming is variable and is selectable by a user and/or by a control module. Such variations may provide a dark background against which an image being viewed by a user will appear brighter with higher contrast, and thus may be easier to see.

Various types of input and output coupling elements may be used. In some embodiments, the input and output coupling elements may include leaky-mode grating-based pupil expander windows (e.g., diffraction gratings) with repeating grating features (e.g., protrusions and/or recesses). The repeating grating features may repeat in one dimension or in two dimensions. The gratings may be formed using a patterned resist material on top of the eyepiece substrate or may be etched into or otherwise integrated with the eyepiece substrate. In some embodiments, the grating structures may include volume-phase material. The input and/or output coupling elements may alternatively or additionally include prisms and/or beamsplitter cascades.

Light projected from the output coupling elements 540, 554 may be focused at optical infinity. One or more lenses 560, 562 may be placed between the output coupling elements 540, 552 and the user's eyes 116, 118, respectively. The lenses may be modestly-powered lenses configured to focus images received by the user 102 at a finite distance. In some embodiments, the lenses may have a power ranging from approximately 1 to 3 diopters to bring the image into focus around an arm's length distance. This allows virtual content to be focused within an arm's reach working range of the user 102. For example, the virtual content may be focused between approximately 30 and approximately 70 centimeters. In some embodiments, the virtual content may be focused at approximately 50 centimeters.

The system 500 further includes a projector 550 that may be placed such that light from the projector is incident on the world side surface of the eyepiece substrate. The projector 550 includes at least one high resolution microdisplay 558 configured to project collimated, spatially distributed light through one or more relay lenses 565 where the light is converted to the angularly multiplexed light 538 incident on at least one input coupling element 536, 552. In some embodiments, the microdisplay 558 includes a fast-switching, high-density spatial light modulator (SLM) such as a microLED display that can alternatingly project a first image associated with a view shown to the right eye and a second image associated with a view shown to the left eye. Thus, the single microdisplay 558 may project temporally multiplexed images to one or more input coupling elements for delivery to one or more eyes. For instance, a microLED display may be used to implement high frame rate switching (e.g., alternating between left and right images at switching rates on the order of 240 Hz), and/or high resolution displays (e.g., 4K or 8K resolution) in a compact projector form factor. For example, non-microLED display, such as a liquid crystal on silicon (LCOS) display, pixel sizes are limited to at least ˜3 microns and the frame rates are limited to approximately 120 Hz due to the use of field-sequential color generation schemes and slow response times of the liquid crystal materials. In contrast, the emitters within a microLED display may be spaced such that a full color red-green-blue (RGB) pixel unit can be located within a smaller pitch than 3 microns, where all three colors can be simultaneously and fundamentally emitted. Also, the switching times of microLED emitters are much faster than 120 Hz such that the switching between right and left projected images can be performed without being noticeable to the user and the form factor of the overall projector can be kept at a handheld size or smaller. Additionally, the pupil size of a microLED projector can be larger than the pupil size of an LCOS-based projector, thus the thickness of the waveguide window used in a system such as optical system 500 can be increased, resulting in increased light guiding efficiency.

The projector 550 may further include a second microdisplay 564 adjacent the first microdisplay 558 such that at least a portion of the microdisplays overlap along the z-axis. The second microdisplay 564 may be laterally offset (e.g., in the x- and/ory-directions) relative to the first microdisplay. In this configuration, the first microdisplay 558 may be dedicated to generating images for a first eye (e.g., the right eye 116) and the second microdisplay 564 may be dedicated to generating images for a second eye (e.g., the left eye 118). For example, spatially modulated light emitted from the first microdisplay passes through one or more relay lenses 565 where it is converted to angularly multiplexed light and is incident on a first input coupling element 536 while spatially modulated light emitted from the second microdisplay passes through one or more relay lenses 565 where it is converted to angularly multiplexed light and is incident on a second input coupling element 552.

From the first and second input coupling elements 536, 552, incoupled light is directed to first and second output coupling elements 540, 554, respectively. The light from the first and second microdisplays may be temporally multiplexed to reduce crosstalk or interference between light associated with the first and second (e.g., right and left) images. In some embodiments, a shutter (not shown) may be disposed between the projector and the first and second input coupling elements to further isolate the left and right image light. One or more portions of the shutter may be configured to switch between open and closed states in sync with the temporal multiplexing between the first and second microdisplay such that the shutter is open over the first input coupling element and closed over the second input coupling element when light from the first microdisplay passes through the shutter. The shutter is open over the second input coupling element and closed over the first input coupling element when light from the second microdisplay passes through the shutter. Thus, the shutter may prevent stray light from the microdisplays from entering the wrong input coupling element which could reduce overall image quality experienced by the user.

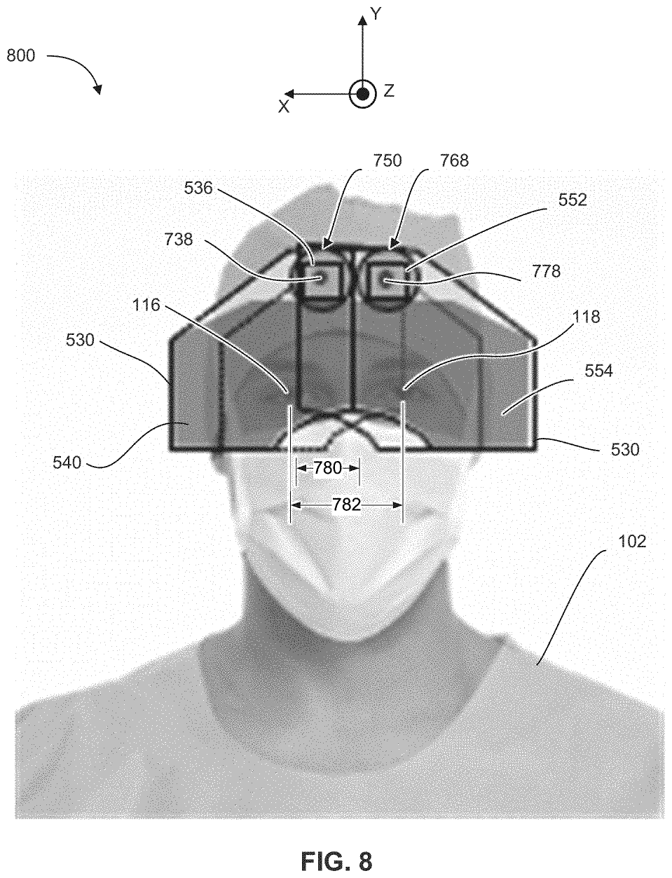

In order to feed light to light pathways associated with both the left and right eyes, the projector 550 is generally centered between the two input coupling elements 536, 552. The projector may be positioned in they direction (i.e., into the page) above, below, or even with the output coupling elements 540, 554. For example, in the configuration shown in FIG. 8, projectors are located above the output coupling elements around the user's forehead area on the nasal side. Other projector placements are possible without departing from the scope of the present disclosure.

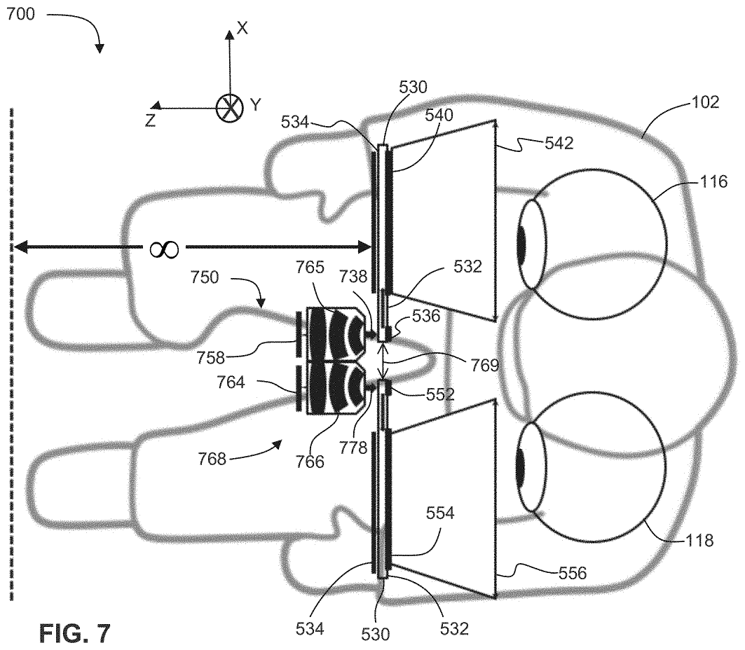

FIG. 7 shows a top-down view of a waveguide-based stereo optical system 700. The system 700 includes some elements similar to those discussed with respect to the system 500 and as such, like components are labeled with like reference numbers. In particular, the eyepiece substrates 530 and optical elements disposed thereon function as described with respect to FIGS. 5 and 6 above.

The system 700 is shown having a first projector 750 which is laterally offset (e.g., in the x direction) from a second projector 768. The first and second projectors are shown on the world side of the eyepiece substrates 530 and project light toward the user 102. The first and second projectors are also positioned on the nasal side of each of eyepiece substrates 530, although other arrangements are possible.

The first projector includes a first microdisplay 758, which may be a high-density microLED display, and one or more relay lenses 765. Light from the first microdisplay 758 passes through relay lenses 765, which converts the light into a first plurality of angularly multiplexed beams that propagate through a first optical pupil 738. Each of the first plurality of angularly multiplexed beams is incident on the first input coupling element 536. In the second projector 768, light from the second microdisplay 764 passes through a second set of relay lenses 766, which converts the light into a second plurality of angularly multiplexed beams that propagate through a second optical pupil 770. Each of the second plurality of angularly multiplexed beams is incident on the second input coupling element 552. Using two independent projectors may allow greater separation (e.g., gap 769 between the first and second input coupling elements 536, 552 which can reduce image artifacts thereby improving image quality. Furthermore, having two independent projectors would allow each projector to have its own input coupling elements and run at normal frame rates. If a single projector is used for projecting both stereo images, the frame rate of the projector should be double the normal frame rates, and a switching mechanism or a shutter should be incorporated into the system to time multiplex the images sent to the left and right fields. Images received by the user's eyes 116, 118 within the eyebox regions 542, 556 may be focused at infinity unless a powered lens or curved eyepiece substrate is included in the system 700.

Similar to the system 500, the system 700 advantageously includes expanded eyebox regions 542, 556 wherein a user may perceive a full field of view, high quality images that retain their native resolution (i.e., the resolution of the image produced by the projector). In contrast to the systems 100, 200, and 300, no spatio/angular trade in resolution is needed in the waveguide-based systems 500, 700, and 800. Thus, images with 4K, 8K, or higher pixel count can be displayed to each eye. Implementing a waveguide-based system using a small pixel pitch, high pixel density SLM, such as a monolithic microLED display, keeps the microdisplay component small and allows other components within the optical train to be similarly small. The resulting systems can be lightweight, compact, and easily moved to or installed in small spaces. As an example, typical pixel pitch of a high-density microLED display may be, for example, full RGB pixel pitch of 2 to 3 microns. For instance, a 2 micron RGB pitch at 4k resolution would result in a display panel of approximately 11 millimeters on the diagonal. Such a display would in turn require a relay lens approximately 15 to 25 millimeters in diameter. In comparison, an LCOS-based SLM has a practical minimum pitch of 3 microns providing sequential color. A 4k display using LCOS would result in a 17 millimeter diagonal panel with a required relay lens diameter of 23 to 33 millimeters, with an additional illumination module to backlight the LCOS pixels, such that the LCOS display would result in at least a 50 to 75% increase in the overall optical system volume, compared to a microLED display system, which does not require backlighting. Thus, the smaller microLED display system would be more readily mountable on, for instance, a boom arm or other easily adjustable arrangement.

As discussed above, the waveguide-based systems 500, 700 produce a virtual image that can be focused at a position substantially coincident with a user's physical hand location without sacrificing image quality. This feature advantageously allows for the superposition of visual and physical fields for activities benefiting from close proximity between the projected content (e.g., virtual images) and the physical environment (e.g., the user's hands and/or tools), such as in telesurgery applications. In some embodiments, optical magnification of the projected image can be performed using only a single lens per eye, as discussed above. The quality of the single lens can be much higher than the plurality of lenslets described with respect to FIGS. 2 and 3, and correspondingly, image quality in systems using a single lens per eye will be higher with significantly fewer artifacts and imposed textures.

Expanded eyebox allows the system to be used by people having widely varying IPDs without any loss in image quality for people having wide or narrow IPDs. In addition, the expanded eyebox regions allow users the freedom of greater head and eye motion while still maintaining overlap with the eyebox regions, and thus, still viewing the full field of view, high resolution, high quality image. The systems 500, 700 therefore provide improved image quality and ergonomics for users.

A further advantage of the systems 500, 700 is the compact size. Referring to FIG. 8, a front view of a system 800 in front of the user 102 is shown. System 800 may include components and advantages similar to those described with respect to system 700 and FIG. 7 above. Like reference numbers are used to label like components.

FIG. 8 shows that projectors 750, 768 and corresponding input coupling elements 536, 552 may be placed above the output coupling elements 540, 554 in order to bring the output coupling elements closer together. In some embodiments, there is only a small gap between the output coupling elements, wherein the gap is determined by geometric constraints imposed by the IPD and by the facial features of the user. In some embodiments, a single, undivided monolithic waveguide panel can be implemented. The size of footprint of output coupling elements 540, 554 on the eyepiece substrates 530 may be selected such that horizontal stereo views are preserved even when the user 102 moves laterally (i.e., in the x direction) a distance 780 which may be up to half of the user's IPD 782 in both left and right directions (total of the full IPD). In this example, if the user 102 moves laterally by a distance greater than the distance 780, both eyes may fall within a single eyebox region such that both eyes receive the same image and the stereo view is lost. This said, in some applications it may be acceptable or even preferable to have a monoscopic view present in both eyes at these high displacement positions, rather than no view at all or a monoscopic view in only one eye as in the case of refractive optics.

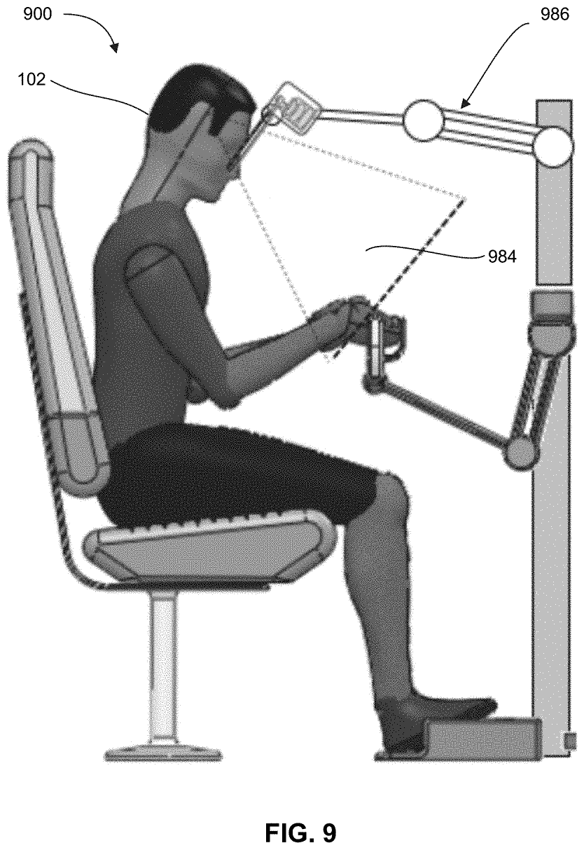

FIG. 9 is a side view of a system 900 similar to the system 800 described above. In the system 900, powered lenses may be included to focus an image at a distance less than optical infinity. For example, the image may be focused less than arm's length from the user 102 within image area 984. Since the image is a virtual image with a finite focal distance, the user may naturally focus their eyes at the position corresponding to the activity of their hands, which may help in cognitive load reduction associated with non-coincident hand motions and optical focus. In addition to optical components, the system 900 may include an articulated boom mount 986 on which the optical components are supported. A boom-mounted system may have ergonomic advantages over head-mounted displays in that the weight of the system is supported off-user and can be adjusted to accommodate users or chairs of different heights. The system 900 may further include other user input means, such as a keyboard, mouse, joystick, buttons, touch screen, and/or other application-specific tools having one or more sensors thereon. Inputs from the user via the user input means may be transmitted to a local or remote processor and/or may be used as instructions for controlling remote equipment in substantially real time.

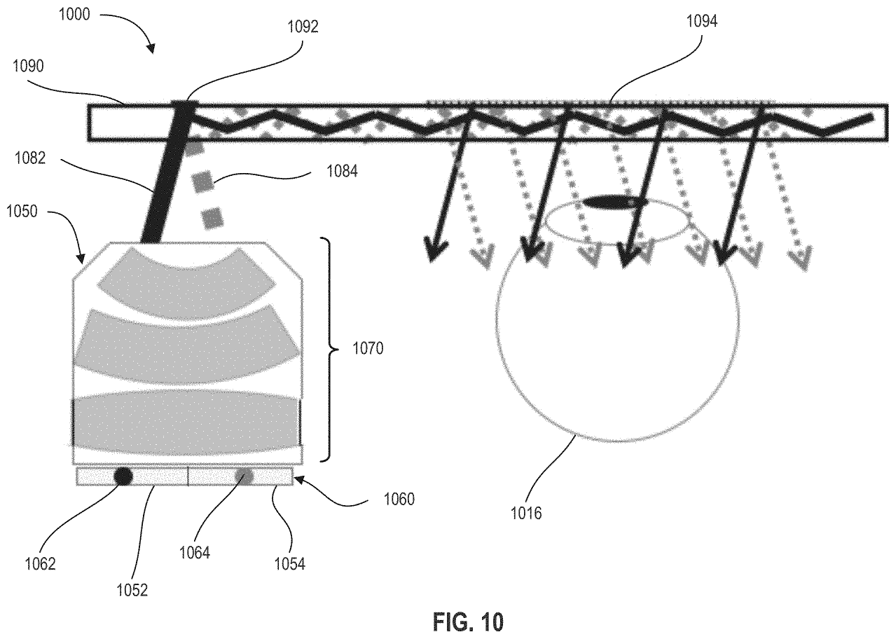

FIG. 10 illustrates a top-down view of example light paths through an eyepiece substrate in a conventional diffractive waveguide eyebox-expanding optical system. As shown in FIG. 10, an optical system 1000 includes operates to direct images toward an eye 1016 using a microdisplay system 1050. Microdisplay system 1050 includes a pixelated emissive SLM 1060. Pixelated emissive SLM 1060 includes first and second pixels 1052 and 1054, respectively, including first and second emitters 1062 and 1064, respectively. Additional pixels and corresponding emitters in pixelated emissive SLM 1060 contribute to form a complete image to be transmitted to eye 1016. Microdisplay system 1050 also includes relay optics 1070 configured for transmitting first and second light rays 1082 and 1084, respectively, emitted from first and second emitters 1062 and 1064, respectively, toward a waveguide 1090. First and second light rays 1082, 1084 are incident on an in-coupling grating 1092, which directs first and second light rays 1082, 1084 through waveguide 1090 by TIR. First and second light rays 1082, 1084 are guided through waveguide 1090, then directed toward eye 1016 by an exit-eyebox expander grating 1094.

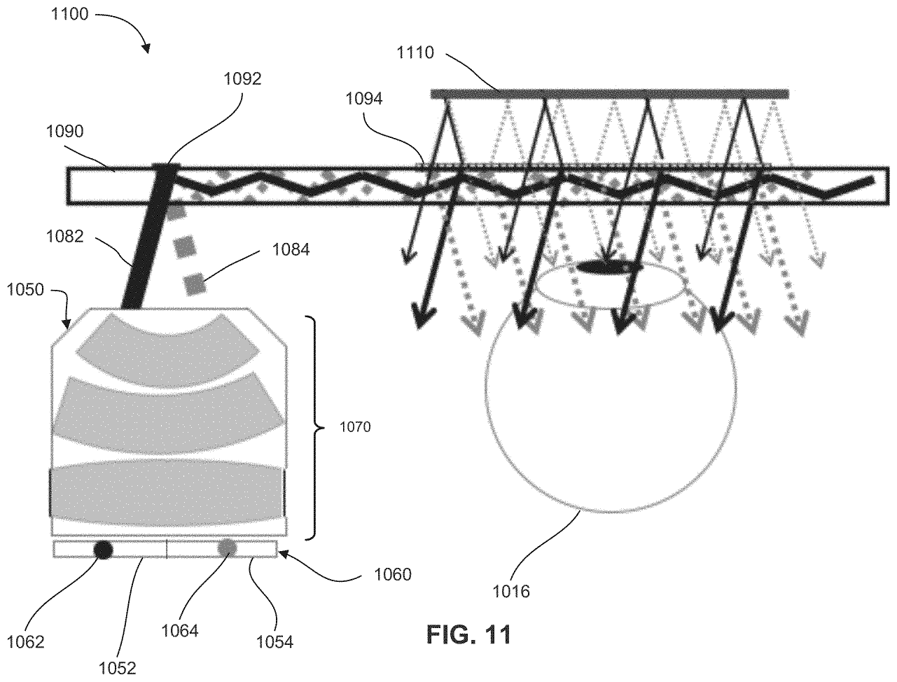

FIG. 11 illustrates a top-down view of example light paths through an eyepiece substrate incorporating a reflective surface to redirect forward-diffracted image light from a waveguide-based optical system. Optical system 1100 includes the same microdisplay system 1050 directing image light into waveguide 1090 via in-coupling grating 1092, as shown in FIG. 10. In addition to exit-eyebox expander grating 1094, optical system 1100 further includes a reflective layer 1110 to redirect light diffracted away from eye 1016 by exit-eyebox expander grating back toward eye 1016. Reflective layer 1110 can optionally be formed as a coating directly adjacent to exit-eyebox expander grating 1094.

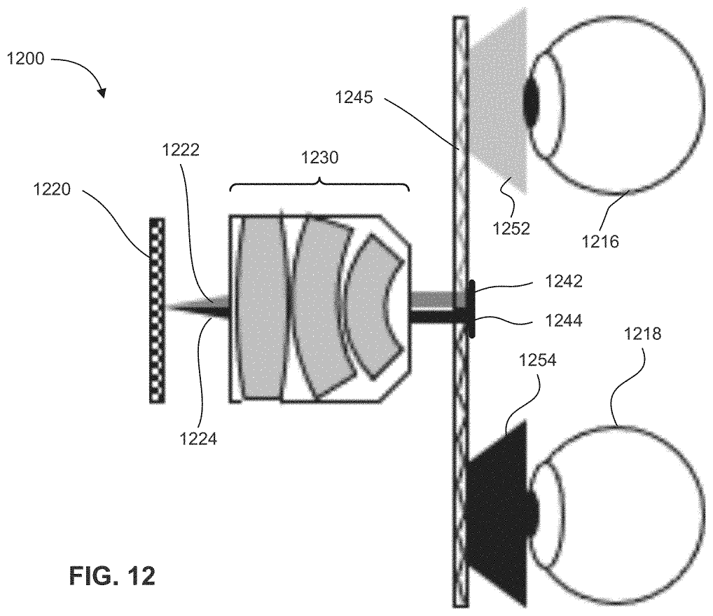

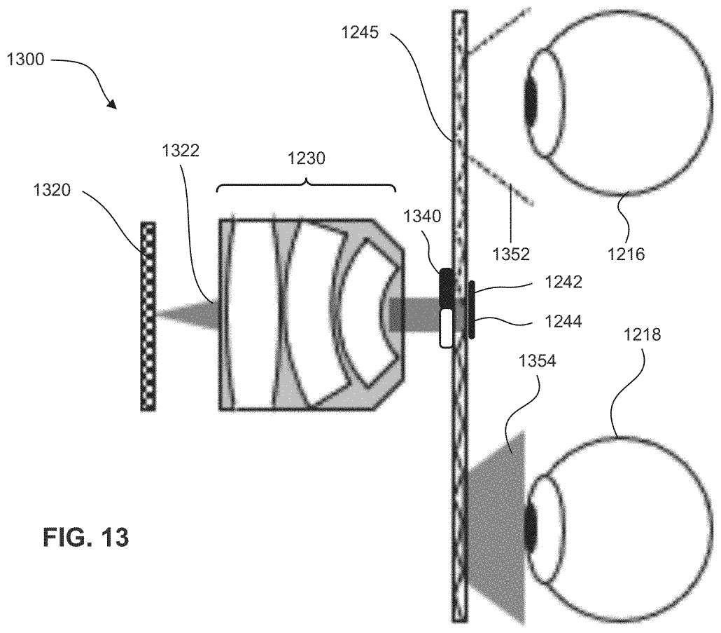

FIGS. 12 and 13 show two embodiments in which a single microdisplay is used to provide stereoscopic images. Referring first to FIG. 12, FIG. 12 illustrates a top-down view of a multiplexed, waveguide-based optical system, in accordance with an embodiment. An optical system 1200 is configured for forming stereoscopic images for viewing by right eye 1216 and 1218, and includes an emissive SLM 1220. Emissive SLM 1220 includes multidirectional pixels, in which each pixel is capable of providing light of a specific wavelength, intensity, and directionality, such as first and second light beams 1222 and 1224, respectively. Optical system 1200 also includes relay optics 1230 for collimating first and second light beams 1222, 1224 toward first and second in-coupling elements 1242 and 1244, respectively. First and second in-coupling elements 1242, 1244 are configured such that first in-coupling element 1242 directs first light beam 1222 within a waveguide 1245 toward right eye 1216, while second in-coupling element 1244 directs second beam 1224 toward left eye 1218. Using one of the out-coupling arrangements illustrated in FIGS. 10 and 11, for example, first light beam 1222 forms a first light cone 1252 viewable by right eye 1216, while second light beam 1224 forms a second light cone 1254 viewable by left eye 1218. In other words, each pixel of emissive SLM 1220 may contain separate left and right view sub-pixels. Then suitable microlens or other optics, such as relay optics 1230 and first and second in-coupling elements 1242, 1244 can be used to angularly separate the output of each pixel of emissive SLM 1220 such that optical system 1200 forms spatially-separated images aligned with respective incoupling elements in an angularly-multiplexed configuration.

Alternatively, FIG. 13 illustrates a top-down view of a temporally-multiplexed, waveguide-based optical system, in accordance with an embodiment. An optical system 1300 includes the same relay optics 1230, first and second in-coupling elements 1242, 1244 and waveguide 1245. In optical system 1300, an emissive SLM 1320 is operated such that each pixel emits light across a wide angle such that a relay optics 1230 directs a single light beam toward a shutter 1340. Shutter 1340 alternates transmission of light toward first and second in-coupling elements 1242, 1244 to form first and second light cones 1352 and 1354, respectively, in a temporally-multiplexed manner.

The embodiments illustrated in FIGS. 12 and 13 are advantageous in that they enable stereoscopic imaging using a single optical system, including a single SLM and one set of relay optics.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention.

In some embodiments, the images displayed by one or more of the optical systems described herein may be directly received by or otherwise derived from remote video. For example, the images projected to the user may be streamed in substantially real-time from a surgical camera on or inside of a patient undergoing telesurgery. The user may make decisions and movements with the user input means to control robotic surgery equipment that replicates the user's motions in substantially real-time, thereby performing remote surgery on the patient.

Various alternative or additional configurations or components may be implemented in one or more of the waveguide-based optical systems described above. In some embodiments, multiple stacked layers (i.e., aligned along a viewing axis in the z direction) of eyepiece substrates may be used instead of one. This may allow the optical system to more efficiently divide color components or portions of an image field of view between the various layers. Additional microdisplays or projectors may be added in order to feed separated optical pupils to one or more input optical elements to divide the color or field of view components among the different layers of eyepiece substrates.

In addition to the number of layers of eyepiece substrate used, the material of the eyepiece substrates may be selected to support a particular number of colors or a particular field of view. The refractive index of the substrate material corresponds to the size of the field of view that can be supported in TIR within the substrate material. For example, lithium niobate has a high index of refraction (n=2.3) and can support a field of view of approximately 90°. As described herein, the eyepiece substrates are generally planar with minimal thickness variation; however, curved or freeform substrates may also be used as matter of design choice.

Some differentiating factors of the embodiments described herein are: 1) flexibility in the size of the waveguides; 2) employment of the large waveguides to enable significant head motion in regular use, in comparison to a head-mounted display (HMD), which are attached to the head such that there should be minimum displacement of the HMD from the eyes/head; 3) the ability to use thicker substrates with larger optics given the divergence of microLED pixel light; and 4) the use of large waveguides to produce a stereo window using a single set of microLED display and relay optics.

### Combinations of Features

Features described above as well as those claimed below may be combined in various ways without departing from the scope hereof. The following enumerated examples illustrate some possible, non-limiting combinations.

(A1) A stereo viewing system includes a projector and an eyepiece. The projector incudes a first microdisplay and is configured to emit spatially modulated light associated with a first image and spatially modulated light associated with a second image. The eyepiece includes an eyepiece substrate, a first input coupling element, a first output coupling element, a second input coupling element, and a second output coupling element. The eyepiece substrate has a user-side surface. The first input coupling element is configured to receive the spatially modulated light associated with the first image from the projector and incouple the spatially modulated light associated with the first image into the eyepiece substrate. The first output coupling element is configured to project at least a portion of the incoupled spatially modulated light out of the eyepiece substrate from the user-side surface. The second input coupling element is configured to receive the spatially modulated light associated with the second image from the projector and incouple the spatially modulated light associated with the second image into the eyepiece substrate. The second output coupling element is configured to project at least a portion of the incoupled spatially modulated light out of the eyepiece substrate from the user-side surface.

(A2) Embodiments of system (A1) further include a mirror coating on the world-side of the at least one eyepiece substrate. The mirror coating may be aligned with the first output coupling grating. In embodiments, the mirror coating is one of a broadband mirror coating and a narrow band mirror coating.

(A3) In embodiments of either one of system (A1) and (A2), at least one of (i) the first input coupling element is a first input coupling grating, and (ii) the first output coupling element is a first output coupling grating. At least one of the first output coupling grating and the second output coupling grating may be formed from functional resist. In embodiments, at least one of the first output coupling grating and the second output coupling grating is integrally formed with the first eyepiece substrate. At least one the first output coupling grating and the second output coupling grating may be formed of a volume-phase material, such as a photopolymer.

(A4) In embodiments of any one of systems (A1)-(A3), the eyepiece substrate is formed of glass, polymer, lithium niobate, or a combination thereof.

(A5) In embodiments of any one of systems (A1)-(A4), the first projector is disposed on the user side of the first eyepiece substrate.

(A6) In embodiments of any one of systems (A1)-(A4), the first projector is disposed on the world side of the first eyepiece substrate.

(A7) In embodiments of any one of systems (A1)-(A6), one or more of the first input coupling element and the first output coupling element includes a beamsplitter.

(B1) In embodiments a stereo viewing system includes a first projector and a first eyepiece stack. The first projector includes a first microdisplay configured to emit spatially modulated light associated with a first image and a second microdisplay configured to emit spatially modulated light associated with a second image. The first eyepiece stack includes at least a first eyepiece and a second eyepiece aligned along a viewing axis. The first eyepiece includes a first eyepiece substrate having a first user-side surface, a first input coupling element, and a first output coupling element. The second eyepiece includes a second eyepiece substrate having a second user-side surface, a second input coupling element, and a second output coupling element.

The first input coupling element is configured to incouple the spatially modulated light associated with the first image into the first eyepiece substrate. The first output coupling element is configured to project at least a portion of the incoupled spatially modulated light out of the first eyepiece substrate from the first user-side surface. The second input coupling element is configured to incouple the spatially modulated light associated with the second image into the second eyepiece substrate. The second output coupling element is configured to project at least a portion of the incoupled spatially modulated light out of the second eyepiece substrate from the user-side surface.

Accordingly, many different embodiments stem from the above description and the drawings. It will be understood that it would be unduly repetitious and obfuscating to literally describe and illustrate every combination and subcombination of these embodiments. As such, the present specification, including the drawings, shall be construed to constitute a complete written description of all combinations and subcombinations of the embodiments described herein, and of the manner and process of making and using them, and shall support claims to any such combination or subcombination.

What is claimed is:

1. A stereo viewing system comprising:
a projector comprising a first microdisplay, wherein the projector is configured to emit spatially modulated light associated with a first image and spatially modulated light associated with a second image; and
an eyepiece comprising:
an eyepiece substrate having a user-side surface;
a first input coupling element configured to receive the spatially modulated light associated with the first image from the projector and incouple the spatially modulated light associated with the first image into the eyepiece substrate;
a first output coupling element configured to project at least a portion of the incoupled spatially modulated light out of the eyepiece substrate from the user-side surface;
a second input coupling element configured to receive the spatially modulated light associated with the second image from the projector and incouple the spatially modulated light associated with the second image into the eyepiece substrate; and
a second output coupling element configured to project at least a portion of the incoupled spatially modulated light out of the eyepiece substrate from the user-side surface.

2. The system of claim 1, wherein the first microdisplay is configured to emit the spatially modulated light associated with the first image and the spatially modulated light associated with the second image.

3. The system of claim 2, wherein the first microdisplay is configured to temporally multiplex emission of the spatially modulated light associated with the first image and the spatially modulated light associated with the second image.

4. The system of claim 3, further comprising a shutter between the first projector and the first and second input coupling elements, wherein the shutter is configured to synchronize with the temporally multiplexed emission of spatially modulated light associated with the first and second images.

5. The system of claim 4, wherein a first portion of the shutter disposed between the projector and the first input coupling element is configured to transmit the light associated with the first image, and wherein a second portion of the shutter disposed between the projector and the second input coupling element is configured to block the light associated with the first image.

6. The system of claim 1, further comprising an additional eyepiece substrate, wherein the first input coupling element and the first output coupling element are disposed on the eyepiece substrate, and the second input coupling element and the second output coupling element are disposed on the additional eyepiece substrate.

7. The system of claim 1, wherein the projector further comprises a second microdisplay, wherein the first microdisplay is configured to emit the spatially modulated light associated with the first image and the second microdisplay is configured to emit the spatially modulated light associated with the second image.

8. The system of claim 7, wherein the first and second microdisplays are laterally offset relative to each other along a first direction, parallel to the user-side surface, such that spatially modulated light associated with the first image is received by the first input coupling element and spatially modulated light associated with the second image is received by the second input coupling element, wherein the first and second input coupling elements are laterally offset along the first direction.

9. The system of claim 8, wherein the first and second microdisplays are stacked along a second direction that is substantially perpendicular to the first direction.

10. The system of claim 7, wherein at least one of the first microdisplay and the second microdisplay comprises a microLED display.

11. The system of claim 10, wherein the microLED display is a monolithic microLED display.

12. The system of claim 10, wherein a pixel resolution of the microLED display is at least 4K.

13. The system of claim 12, wherein the pixel resolution of the microLED display is at least 8K pixel resolution.

14. The system of claim 1, wherein the eyepiece substrate comprises a world-side surface opposite the user-side surface, and wherein the system further comprises a dimming panel disposed on the world-side surface.

15. The system of claim 14, wherein the dimming panel is a programmable dimming panel.

16. The system of claim 1, further comprising a lens on the user-side surface of at least one of the first and second output coupling elements.

17. The system of claim 16, wherein a focal length of the lens is approximately 50 centimeters.

18. The system of claim 1, wherein the first input coupling element is one of a 1-dimensional grating and a 2-dimensional grating.

19. The system of claim 1, wherein the first output coupling element is one of a 1-dimensional grating and a 2-dimensional grating.

20. The system of claim 1, wherein at least one of the first input coupling element, the first output coupling element, the second input coupling element, and the second output coupling element is integrally formed with the eyepiece substrate.
